(19) United States
(12) Patent Application Publication
(10) Pub. No.: US 2008/0183443 A1
(43) Pub. Date: Jul. 31, 2008

(54) STATISTICAL SIMULATION OF ON CHIP INTERCONNECTS

(76) Inventors: David Goren, Nesher (IL); Shlomo Shlafman, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/669,173

(22) Filed: Jan. 31, 2007

(51) Int. Cl. G06F 17/18; G06F 17/50

(52) U.S. Cl. 703/2; 703/14

(57) ABSTRACT

Systems and methods for statistical simulation of on chip interconnect models are provided. In on embodiment, the method comprises creating a non-linear on chip interconnect simulation model from parameters associated with the silicon chip process manufacturing; pre-calculating a linear function from the non-linear simulation model; replacing increments of variable parameters with statistical parameters; and performing, preferably, a Monte Carlo or corner simulation using the linear function.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to simulation of various properties of on chip interconnects in an integrated circuit and, more particularly, to a system and method for efficiently performing a Monte Carlo simulation of a transmission line interconnect model.

### BACKGROUND

As operating speeds in integrated circuits (i.e., chips) reach the multi-Gigahertz range, the properties of on-chip interconnects (i.e. wires connecting circuit components) have increasing influenced the overall chip performance. By one estimate, on-chip interconnect delay is responsible for more than 70% of the total signal delay in some chip designs.

For the above reasons, fast and accurate simulation of a chip design based on the properties of the chip's interconnect components is more important than ever. Such simulations can be extremely complex, however, because of the large process variations in modern scaled down technologies and the high-speed design requirements that are characterized by the frequent need for true transient time domain simulations and high signal integrity.

Since complex simulation models increase the time associated with designing interconnect components, simulating a complex chip is associated with a longer time to market and sometimes a significant amount of unnecessary redesign. To avoid these problems, early incorporation of simple interconnect models in the design process is highly desirable. This early integration also reduces the need for several design iterations or significant over-design.

A simulation method used to verify the yield of a complex chip design can be based on a Monte Carlo simulation scheme. In the Monte Carlo scheme, a class of computational algorithms is used to simulate the behavior of various physical and mathematical systems. Monte Carlo simulation is distinguishable from other simulation models in that it utilizes stochastic algorithms. In other words, nondeterministic random or pseudo-random number generators are used to help increase the efficiency of the simulation method, as the dimension and complexity of the simulated model increase.

An on-chip interconnect has certain properties that can be represented by the parameters of a simulation model. Any interconnect simulation model, such as the Monte Carlo simulation model, can be implemented based on interconnect parameters associated with resistance (R), inductance (L), and capacitance (C) (i.e., RLC). Most simulators use a conventional Monte Carlo simulation approach for full functional distribution of set of possible outcomes for parameters R, L and C.

Unfortunately, however, the conventional Monte Carlo simulation technique is very time intensive, because it requires recalculating the interconnect parameter values at each iteration of the Monte Carlo simulation (i.e., at every simulation step). Each iteration requires large number of arithmetic operations and calculations before moving on to the next step. Thus, the conventional simulation schemes are very time consuming and also result in generation of a vast volume of executable code that occupies a relatively large amount of storage space.

Improved interconnect simulation models are needed that can overcome the above-mentioned shortcomings.

### SUMMARY

The present disclosure is directed to a system and corresponding method that facilitate the efficient Monte Carlo simulation of on chip interconnects (“interconnects”) based upon pre-calculating a linear approximation on which all later in time simulations can be performed.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, an efficient Monte Carlo simulation scheme for an interconnect is disclosed. The method comprises selecting interconnect parameters to form a first model, processing the first model to create a second model and performing Monte Carlo simulation on the second model.

In one embodiment, the second model is created by way of linearizing the parameters in the first model; pre-calculating at least one derivative of the parameters; replacing an increment of a variable parameter with a statistical parameter; and replacing semi-analytical parameters with the pre-calculated derivative.

In some embodiments, the linearization of the parameters is accomplished by using a linear part of a multi-variable Taylor series around nominal values. The statistical parameter can be a Gaussian variable, for example. The parameters, for example, may be associated with values representing capacitance, resistance, inductance and shunt conductance of one or more circuit components.

In accordance with one embodiment, the derivative values for the parameters are analytically pre-calculated based on a wire model equation. In a one embodiment, the pre-calculated derivative is replaced by central finite differences at a nominal point, for example.

In accordance with another embodiment, a computer program product comprising a computer useable medium having a computer readable program is provided. The computer readable program when executed on a computer causes the computer to create a non-linear simulation model from parameters associated with a process for manufacturing the on chip interconnect; pre-calculate a linear function from the non-linear simulation model; replace increments of variable parameters with statistical parameters; and perform a Monte Carlo simulation using the altered linear function.

In accordance with yet another embodiment, a system for faster Monte Carlo simulation of on chip interconnect models is provided. The system comprises a logic unit for creating a non-linear simulation model with parameters associated with a process for manufacturing the on chip interconnect; a logic unit for pre-calculating a linear function from the above non-linear simulation model; a logic unit for replacing increments of variable parameters with statistical parameters; and a logic unit for performing the fast Monte Carlo simulation using the altered linear function.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates a two-dimensional cross-section of an exemplary transmission line interconnect structure, in accordance with one embodiment.

FIG. 2 is a flow diagram of a method for speeding up a Monte Carlo simulation of an on chip interconnect, in accordance with one embodiment.

FIG. 3 is a flow diagram of an exemplary method for processing an on chip interconnect model, in accordance with an exemplary embodiment.

FIGS. 4 and 5 are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

The present disclosure is directed to systems and corresponding methods for simulation of on chip interconnects (“interconnects”), and particularly the simulation of transmission line interconnects. Accordingly, a linearized simulation scheme is provided that is sufficiently accurate for modeling the parameters of an interconnect.

Numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

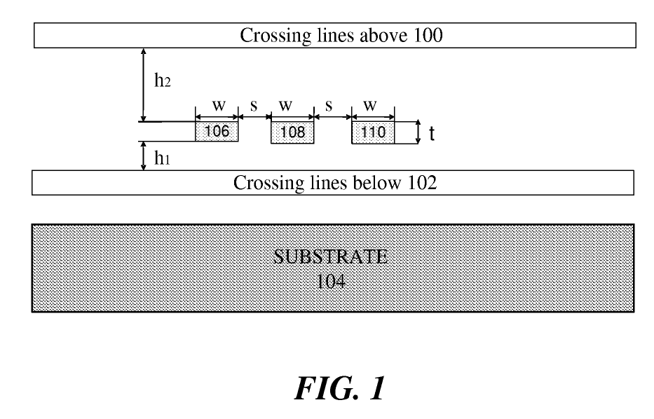

Referring to FIG. 1, an exemplary transmission line interconnect structure is illustrated having a silicon substrate 104 with a first set of transmission lines 100 and a second set of transmission lines 102 that orthogonally cross, respectively, above and below, a third set of transmission lines 106, 108 and 110, as shown. In one embodiment, an on chip transmission model is used to simulate the third set of the transmission lines based on the first and second sets of transmission lines.

In the following, one or more exemplary embodiments are particularly described as applicable to simulation of transmission line interconnects. It is noteworthy, however, that the principals and conventions disclosed here are equally applicable to simulation of any type of on chip interconnect.

In the exemplary embodiment illustrated in FIG. 1, upper and lower dielectric layers with respective thicknesses of “h1” and “h2” separate the first, second and third sets of transmission lines. Interconnect parameter values that are associated with manufacturing an integrated circuit (i.e., chip) are the thickness (t), the width (w) and the spacing (s) between adjacent interconnect lines 106, 108 and 110. In certain embodiments, other parameter values associated with metal conductivity, heights (“h1” and “h2”) and dielectric constants of a circuit component may be utilized as well.

In one embodiment, linearized (i.e., first order) estimations of one or more of said parameters are used to implement an interconnect model. Despite that process variation and temperature can affect the on-chip interconnect capacitance (C), series resistance (R), inductance (L) and shunt conductance (G), linear modeling techniques are sufficiently accurate in well-behaved parameters such as t, w and s, and thus there is no need to rely on higher order modeling techniques for better accuracy.

As such, in accordance with one aspect of the invention, even though linearization of t, w and s parameters may introduce a higher level of error in simulation (i.e., in comparison with simulation models that use non-linearized values), in well-behaved interconnect structures, the level of error is sufficiently low to provide an accurate simulation model for the purpose of testing the operational integrity of the chip design, as provided in further detail below.

In one embodiment, since the interconnect resistance is directly proportional to the sheet resistance, the linearization versus the sheet resistance is exact. Furthermore, since the resistance is inversely proportional to the line width, the line width is a well-behaved function that can be approximated by the line width's first order. The standard deviation in the width is such that, for example, three standard deviations (σ) is less than a small predetermined percentage of the width. The same principal also applies to the variation of the line thickness, and in one embodiment, the thickness variations are included within the sheet resistance variations.

In another embodiment, due to the fringing capacitance terms, the interconnect capacitance is a sub-linear function of the interconnect's width and thickness. The capacitance, preferably, changes less rapidly than the inverse of the separation to the shielding above and below (h1 and h2) and the inverse of the separation to the nearest coplanar wire (s). Since the capacitance functions are well-behaved functions, these functions may be approximated by their linear order, as shown in the numerical examples provided below.

It is noteworthy that the provided examples consider the combined deviation due to all the variables affecting the capacitance, and that the relative process induced standard deviation in all these geometry parameters are small, so that in the provided exemplary embodiments herein three standard deviations (C) is less than 10 percent, for example.

In some embodiments, the inductance changes more slowly than the capacitance depending on the above-referenced geometry variables. The inductance is logarithmic with the distance to the current return path, and is less than inversely proportional to the line width. In certain embodiments, the linear orders approximate the inductance variations more accurately than the capacitance variations.

Equation 1 below provides an example for using numerical results for the capacitance variations and estimate the linearization error of the static capacitance:

C=C(w,t,h₁,h₂,d,s) (1)

In accordance with one embodiment, the capacitance may be presented by a Taylor series around a nominal value, as provided in equations 2 through 5 below:

$$\begin{matrix}C ( w , t , {h}_{1} , {h}_{2} ) = C ( {w}^{( n )} , {t}^{( n )} , {h}_{1}^{( n )} , {h}_{2}^{( n )} ) + dC ( {w}^{( n )} , {t}^{( n )} , {h}_{1}^{( n )} , {h}_{2}^{( n )} ) + ( 1 / 2 ) * {d}^{2} C ( {w}^{( n )} , {t}^{( n )} , {h}_{1}^{( n )} , {h}_{2}^{( n )} ) + … \\ where & ( 2 ) \\ dC ( {w}^{( n )} , {t}^{( n )} , {h}_{1}^{( n )} , {h}_{2}^{( n )} ) = {dC}_{w} ( {w}^{( n )} , {t}^{( n )} , {h}_{1}^{( n )} , {h}_{2}^{( n )} ) + {dC}_{t} ( {w}^{( n )} , {t}^{( n )} , {h}_{1}^{( n )} , {h}_{2}^{( n )} ) + … \\ {dC}_{w} ( {w}^{( n )} , {t}^{( n )} , {h}_{1}^{( n )} , {h}_{2}^{( n )} ) = \frac{\partial C ( {w}^{( n )} , {t}^{( n )} , {h}_{1}^{( n )} , {h}_{2}^{( n )} )}{\partial w} dw \\ {dC}_{t} ( {w}^{( n )} , {t}^{( n )} , {h}_{1}^{( n )} , {h}_{2}^{( n )} ) = \frac{\partial C ( {w}^{( n )} , {t}^{( n )} , {h}_{1}^{( n )} , {h}_{2}^{( n )} )}{\partial t} dt , \\ ⋯ & ( 3 ) \\ {d}^{2} C ( {w}^{( n )} , {t}^{( n )} , {h}_{1}^{( n )} , {h}_{2}^{( n )} ) = {dC}_{{w}^{2}}^{2} ( {w}^{( n )} , {t}^{( n )} , {h}_{1}^{( n )} , {h}_{2}^{( n )} ) + {dC}_{{t}^{2}}^{2} ( {w}^{( n )} , {t}^{( n )} , {h}_{1}^{( n )} , {h}_{2}^{( n )} ) + {dC}_{wt}^{2} ( {w}^{( n )} , {t}^{( n )} , {h}_{1}^{( n )} , {h}_{2}^{( n )} ) + … & ( 4 ) \\ {d}_{{w}^{2}}^{2} C ( {w}^{( n )} , {t}^{( n )} , {h}_{1}^{( n )} , {h}_{2}^{( n )} ) = \frac{{\partial }^{2} C ( {w}^{( n )} , {t}^{( n )} , {h}_{1}^{( n )} , {h}_{2}^{( n )} )}{{\partial }^{2} w} {dw}^{2} \\ {d}_{{t}^{2}}^{2} C ( {w}^{( n )} , {t}^{( n )} , {h}_{1}^{( n )} , {h}_{2}^{( n )} ) = \frac{{\partial }^{2} C ( {w}^{( n )} , {t}^{( n )} , {h}_{1}^{( n )} , {h}_{2}^{( n )} )}{{\partial }^{2} t} {dt}^{2} \\ {d}_{wt}^{2} C ( {w}^{( n )} , {t}^{( n )} , {h}_{1}^{( n )} , {h}_{2}^{( n )} ) = \frac{{\partial }^{2} C ( {w}^{( n )} , {t}^{( n )} , {h}_{1}^{( n )} , {h}_{2}^{( n )} )}{\partial w \partial t} dwdt , … & ( 5 )\end{matrix}$$

For the purpose of illustration, in the calculations provided below the derivatives are replaced by central finite differences, where σ is the standard deviation for each of three standard deviations (σ) variable (dw, dt, etc.). Furthermore, the following is an investigation of a set of single transmission lines (T-lines) with side shield and with optional crossing lines above and below, as shown in FIG. 1.

In one embodiment, the values of nominal capacitance as well as the norm for the first and the second finite derivatives are calculated. The norm is a preferred measure because the variances of the independent variables are added, where the norms are defined by equation 6:

|dC|=\sqrt{d_{w}C*d_{w}C+dₜC*dₜC+ . . .}

|d²C|=\sqrt{d²_{w}_{²}C*d²_{w}_{²}C+d²ₜ_{²}C*d²ₜ_{²}C+ . . .} (6)

In an exemplary embodiment where the length of the wire is 100 um, the results are as illustrated in Table 1 below:

TABLE 1

| | Cross | Cross | W | S | C⁽ⁿ⁾ | \|dC⁽ⁿ⁾\| | (½)\|d²C⁽ⁿ⁾\| |
|---|---|---|---|---|---|---|---|
| N | under | over | [um] | [um] | [F] | [F] | [F] |
| 1 | NO | NO | 1 | 1 | 1.12e−14 | 4.90e−16 | 1.18e−17 |
| 2 | YES | NO | 1 | 1 | 2.06e−14 | 2.31e−15 | 3.98e−16 |
| 3 | YES | NO | 0.5 | 0.5 | 1.49e−14 | 1.37e−15 | 3.32e−16 |
| 4 | NO | NO | 0.4 | 0.4 | 1.57e−14 | 1.13e−15 | 8.45e−17 |
| 5 | NO | NO | 3 | 2 | 1.43e−14 | 2.94e−16 | 1.10e−17 |
| 6 | NO | NO | 2 | 2 | 1.04e−14 | 2.58e−16 | 5.79e−18 |
| 7 | YES | NO | 2 | 2 | 1.85e−14 | 1.25e−15 | 1.91e−16 |
| 8 | NO | YES | 2 | 2 | 1.27e−14 | 2.93e−15 | 6.36e−16 |
| 9 | YES | YES | 2 | 1 | 5.73e−14 | 4.44e−15 | 7.49e−16 |
| 10 | YES | YES | 2 | 2 | 1.61e−14 | 6.13e−15 | 8.99e−17 |

Table 1 shows that the norm for the second finite difference (½)|d²C⁽ⁿ⁾| is much smaller than the norm of the first finite difference |dC⁽ⁿ)| and is very much smaller than the linearized part of C which is used in the suggested linear approximation: C(n)+|dC⁽ⁿ)|.

As stated earlier, the inductance variations are even smaller and the simple form of the resistance expressions cause the resistance linearization to be exact. Additionally, histograms for the conventional and the linearized Monte Carlo simulations are very close for on-chip interconnects. Accordingly, the linearization approach disclosed herein is a viable method to increase the efficiency and speed of Monte Carlo simulations for on-chip interconnects.

For example, M arithmetic operations utilized to calculate C and R in a first non-linear model; and X*M operations are utilized to pre-compute the derivatives. If each Monte Carlo step uses the linear model, then Y arithmetic operations are utilized. As such for N steps of conventional Monte Carlo, M*N operations are utilized, whereas for the same N steps using the linear model X*M+Y*N arithmetic operations are utilized. Thus, for large N there are a smaller number of arithmetic operations, when using the linear model.

As such, as the number of steps N increases, so does the efficiency (E) of the linearized model. The efficiency of the linearized model in comparison to its non-linearized counterpart can be calculated according to the following formula: E=(M*N)/(X*M+Y*N). Thus, for example, if X=15, Y=15, N=500 and M=5000, then E=5000*500/(15*5000+15*500)=30. That is, the simulation efficiency is increased by a factor of 30.

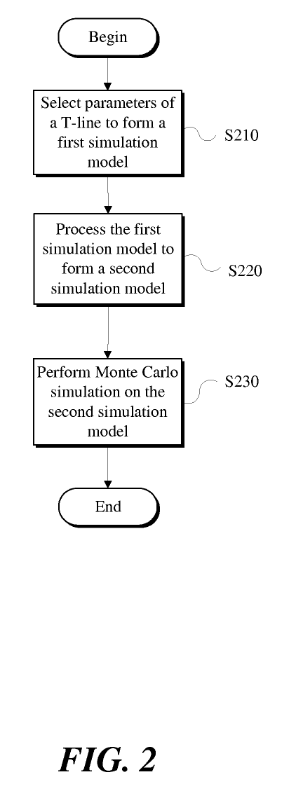

Referring to FIG. 2, in one embodiment, a method for simulating on-chip interconnect T-lines comprises the process of selecting performance parameters associated with the T-line until a first simulation model is formed (S210). The first simulation model is then processed to form a second simulation model (S220).

As provided in more detail below, the second simulation model is derived from the process of linearizing the first simulation model parameters and pre-calculating a derivative of the model parameters to form a linear (i.e., first order) function. Preferably, a Monte Carlo simulation is then performed on the second simulation model (S230).

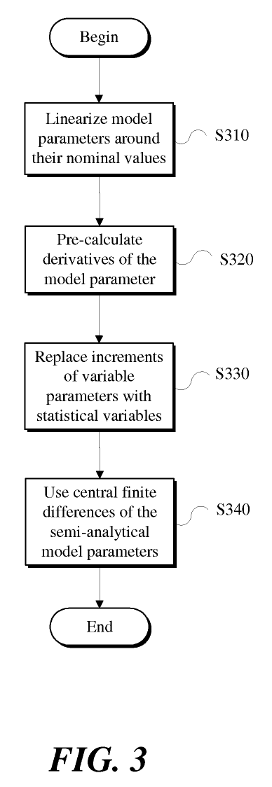

FIG. 3 illustrates an exemplary method for processing the first simulation model to produce the second simulation model. The first simulation model can be based on a complex non linear function. In one embodiment, the model parameters are linearized around their nominal values, such that the simulation function is transformed to a linear part of the multi-variable Taylor series around the nominal values (S310).

In alternative embodiments, the linearization approach extends to include higher order elements in the Taylor series. However, a first order approximation is sufficient in certain embodiments. In an exemplary embodiment, the derivatives of the model parameters are pre-calculated (S320). In some embodiments, the derivatives for the Taylor series can be pre-calculated analytically on the wire model equations. In other embodiments, central finite differences at the nominal point can replace the derivatives. In yet other embodiments, various corner simulations may be enabled based on the same linearization approach.

In accordance with one aspect of the invention, the existing statistical dependencies among the process parameters (e.g., metal width, metal thickness, metal separation, sheet resistivity, etc.) are considered in order to reflect the correct statistical distributions of the resulting wire parameters (e.g., capacitance, resistance, inductance, delay, etc). In some embodiments, this is achieved by defining a smaller number of parameters, from the original process parameters, so that the resulting smaller number of parameters are statistically independent.

Another approach is to use dependent statistical variables which reflect the statistical dependence of the process parameters. Accordingly, increments of variable parameters are replaced with statistical (e.g., Gaussian) variables (S330) and central finite differences of the semi-analytical model parameters are used (S340).

Depending on implementation, various linearization procedures and or Taylor series expansion models are utilized in one or more embodiments. It is noteworthy, however, that any linearization or expansion method can be utilized to accomplish the same or similar results.

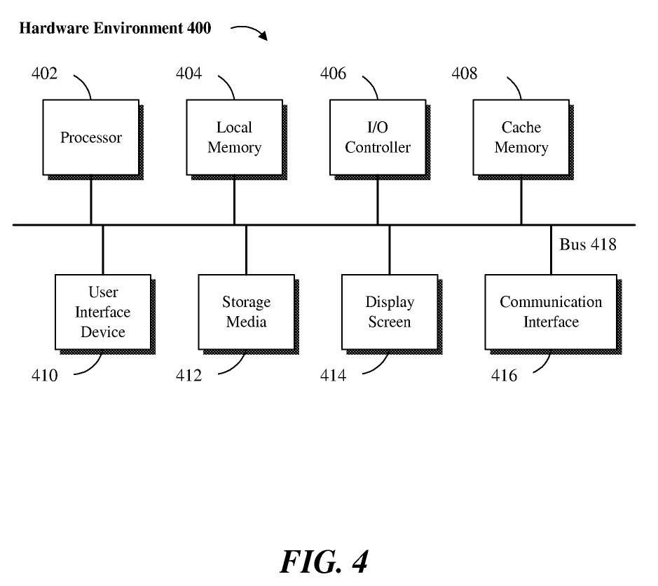

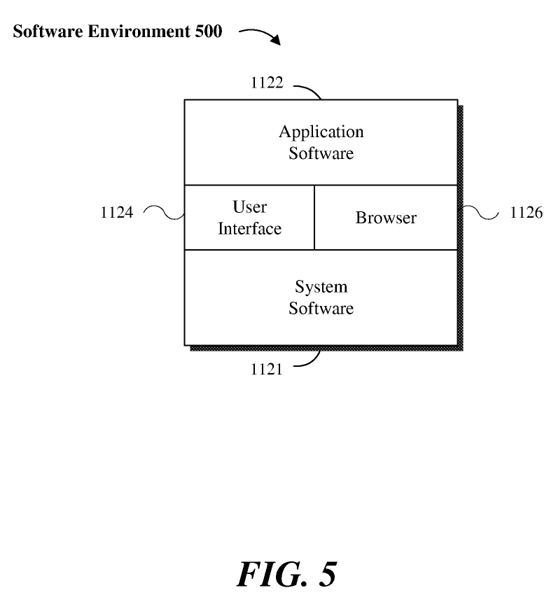

In different embodiments, the invention can be implemented either entirely in the form of hardware or entirely in the form of software, or a combination of both hardware and software elements. For example, with reference to FIGS. 4 and 5, one or more embodiments of the invention may be implemented as at least one of computing system 400 and software environment 500 that comprise a controlled computing system environment that can be presented largely in terms of hardware components and software code executed to perform processes that achieve the results contemplated by the system of the present invention.

Referring to FIGS. 4 and 5, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 506 and application software 502. System software 506 comprises control programs, such as the operating system (OS) and information management systems that instruct the hardware how to function and process information.

In a preferred embodiment, application software 502 is executed on one or more hardware environments to simulate transmission line interconnects as provided earlier. Application software 502 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIGS. 4 and 5, an embodiment of the application software 502 can be implemented as computer software in the form of computer readable code executed on a data processing system such as hardware environment 400 that comprises a processor 402 coupled to one or more memory elements by way of a system bus 418. The memory elements, for example, can comprise local memory 404, storage media 412, and cache memory 408. Processor 402 loads executable code from storage media 412 to local memory 404. Cache memory 408 provides temporary storage to reduce the number of times code is loaded from storage media 412 for execution.

The present invention has been described above with reference to preferred features and embodiments. Those skilled in the art will recognize, however, that changes and modifications may be made in these preferred embodiments without departing from the scope of the present invention. These and various other adaptions and combinations of the embodiments disclosed are within the scope of the invention and are further defined by the claims and their full scope of equivalents.

What is claimed is:

1. A method for statistical simulation of on chip interconnects, the method comprising:
implementing a first simulation model based on one or more parameters used to determine performance of an on chip interconnect;
deriving a reduced second simulation model from the first simulation model, wherein deriving comprises:
linearizing the one or more parameters in the first simulation model;
pre-calculating a derivative of the one or more parameters in the first simulation model;
replacing an increment of at least one variable parameter from among said one or more parameters with a statistical parameter; and
using the second simulation model to perform statistical simulations.

2. The method of claim 1, wherein the statistical parameter is a Gaussian variable.

3. The method of claim 1, wherein the one or more parameters are associated with a process for manufacturing a silicon chip for which the on chip interconnects are modeled.

4. The method of claim 3, wherein the one or more parameters comprise at least one of capacitance, resistance, inductance and shunt conductance.

5. The method of claim 1, wherein the pre-calculated derivative is pre-calculated analytically on a wire model equation.

6. The method of claim 1, wherein the pre-calculated derivative is replaced by central finite differences at a nominal point.

7. A method for simulation of an on chip interconnect model, the method comprising:
creating a non-linear simulation model based on parameters associated with a process for manufacturing an on chip interconnect;
pre-calculating a linear function from the non-linear simulation model;
replacing increments of variable parameters with statistical parameters in the linear function to create a linear simulation model; and
performing a Monte Carlo simulation on the linear simulation model.

8. The method of claim 7, wherein the statistical parameters are Gaussian variables.

9. The method of claim 7, wherein the linear simulation model is created based on a linear part of a multi-variable Taylor series around nominal values.

10. The method of claim 9, wherein a derivative for the Taylor series is pre-calculated analytically on a wire model equation.

11. The method of claim 9, wherein a derivative for the Taylor series is replaced by central finite differences at a nominal point.

12. A system for fast Monte Carlo simulation of on chip interconnect models comprising:
a logic unit for creating a non-linear simulation model from parameters associated with a process for manufacturing an on chip interconnect;
a logic unit for pre-calculating a linear function from the non-linear simulation model;
a logic unit for replacing increments of variable parameters with statistical parameters; and
a logic unit for performing the fast Monte Carlo simulation using the linear function.

13. The system of claim 12, wherein the statistical parameters are Gaussian variables.

14. The system of claim 12, wherein the linear function is a linear part of a multi-variable Taylor series around nominal values.

15. The system of claim 14, wherein a derivative required for the Taylor series is pre-calculated analytically on a wire model equation.

16. The system of claim 14, wherein a derivative required for the Taylor series is replaced by central finite differences at a nominal point.

17. A computer program product comprising a computer useable medium having a computer readable program, wherein the computer readable program when executed on a computer causes the computer to:
create a non-linear simulation model from parameters associated with a process for manufacturing an on chip interconnect;
pre-calculate a linear function from the non-linear simulation model;
replace increments of variable parameters with statistical parameters; and
perform a Monte Carlo simulation using the altered linear function.

18. The computer program product of claim 17, wherein the linear function is a linear part of a multi-variable Taylor series around nominal values.

19. The computer program product claim 18, wherein a derivative required for the Taylor series is pre-calculated analytically on a wire model equation.

20. The computer program product of claim 18, wherein a derivative required for the Taylor series is replaced by central finite differences at a nominal point.
